(19) United States
(12) Patent Application Publication
(10) Pub. No.: US 2006/0148463 A1
(43) Pub. Date: Jul. 6, 2006

(54) Method for restoring automatically an original setting in a mobile device

(75) Inventors: Yuan-Bo Zhu, Taipei (TW); Tony Tsai, Taipei (TW); David Ho, Taipei (TW)

Correspondence Address: GENUS LAW GROUP;LOWE HAUPTMAN & BERNER, LLP, 1700 DIAGONAL ROAD, SUITE 300, ALEXANDRIA, VA, 22314, US

(73) Assignee: Inventec Appliances Corp.

(21) Appl. No.: 11/177,562

(22) Filed: Jul. 8, 2005

(30) Foreign Application Priority Data
Dec. 30, 2004 (TW) 093141508

(51) Int. Cl. H04M 3/00

(52) U.S. Cl. 455/418; 455/412.1

(57) ABSTRACT

A method for restoring automatically an original setting in a mobile device is disclosed in which a monitoring module is included, comprising the steps of memorizing a plurality of initial communication settings by the monitoring module when a SIM card is inserted in the mobile device as a spare copy of parameters, examining a plurality of APs parameters stored in the mobile device, comparing the spare copy of parameters and the plurality of APs parameters, and executing automatically an initial setting process on the mobile device and overwriting the plurality of APs parameters stored in the mobile device. As such, the previous basic settings of the mobile device may be rapidly restored in a simple manner and the mobile device may be restored back to a normally state.

### BACKGROUND OF THE INVENTION

1. Field of the Invention

The present invention relates to a method for restoring original data of a mobile device, and particularly to a method for restoring automatically or manually an original setting in a mobile device.

2. Descriptions of the Related Art

With the rapid improvement and wide acceptances of communications technology, mobile phones have become the most efficient and convenient mobile device. However, although more and more enhanced functions have been provided in the mobile phone, some conditions of malfunction would sometimes happen as the trend of more critical demands on the components of the mobile phone. For example, messages in the mobile phone can not be sent out. This would, at most cases, be resulted from basic communications settings of the mobile phone having been changed when, for instance, a new subscriber information module (SIM) card is inserted into the mobile phone. However, frequent operations on the mobile phone may also lead to disorderliness of the preset functions in the mobile phone. In addition, the changed settings may be retraced to a careless operation on a setting or some settings by a user of the mobile phone. No matter which condition is taken place, the mobile phone may not be operated normally once some setting thereof is changed.

When the mobile phone operates abnormally, the user often does not know which setting has been changed and should be restored in a proper manner. Further, if the settings are not properly modified, the condition may get worse.

Although this problem may be overcome by making use of the maintenance service provided by mobile phone retailers, it is obviously troublesome. If the user chooses to perform a function “Restore Factory Settings” originally provided in the mobile phone, other settings and stored data are required to be transferred to a certain memory so that these settings and stored data being useful to the user may be retained. However, this settings and data transferring work is time consuming and not practicable.

### SUMMARY OF THE INVENTION

It is, therefore, an object of the present invention to provide a method for restoring automatically an original setting in a mobile device so that a function corresponding to the setting in the mobile device may be rapidly restored in a simple manner.

It is another object of the present invention to provide a method for restoring automatically an original setting in a mobile device in a condition that the other settings and stored data in the mobile device are not required to be transferred to another memory before the method is performed.

It is yet another object of the present invention to provide a method for restoring automatically an original setting in a mobile device, through which parameters therein may be regularly examined and overwritten so that a function corresponding to the setting in the mobile device may be performed normally.

To achieve the above objects, the present invention provides a method for restoring automatically an original setting in a mobile device in which a monitoring module is included, comprising the steps of memorizing a plurality of initial communication settings by the monitoring module when a SIM card is inserted in the mobile device, setting the plurality of initial communication settings as a spare copy of parameters on the monitoring module, examining the plurality of access points (APs) parameters stored in the mobile device, and comparing the spare copy of parameters and the plurality of APs parameters, and executing automatically or manually an initial setting process on the mobile device and overwriting the plurality of APs parameters stored in the mobile device when both parameters can not matched. As such, the previous basic settings of the mobile device may be rapidly restored in a simple manner and the mobile device may be restored back to a normally state.

The features, aspects, and advantages of the present invention will become more apparent from the detailed description set forth below, the drawings and the claims.

### BRIEF DESCRIPTION OF THE DRAWINGS

FIG. 1A, FIG. 1B, FIG. 1C and FIG. 1D show, respectively, option menus displayed when a method of restoring automatically settings in a mobile device according to an embodiment of the present invention is performed;

FIG. 2 shows a flowchart illustrating the method of restoring automatically settings in a mobile device according to an embodiment of the present invention; and

FIG. 3 shows a flowchart illustrating the method of restoring automatically settings in a mobile device according to another embodiment of the present invention.

### DETAILED DESCRIPTION OF THE INVENTION

In the present invention, a method for restoring automatically an original setting in a mobile device is provided. At first, a monitoring module is provided in the mobile device. The monitoring module is a multi-functioned unit which is separate with respect to access points (APs) provides service to mobile devices. The monitoring module is capable of examining a plurality of parameters stored and software programs used in the APs. Further, the monitoring module may load a plurality of parameters associated with the wireless application protocols (WAPs), short message service (SMS), enhanced message service (EMS), multimedium service (MMS) and Agile Lambda (wavelength) Switches (ALS) therein.

After a SIM card is inserted into the mobile device having the monitoring module and the mobile device is powered on, the monitoring module conducts the initial setting process in the mobile device and memorizing the parameters of each AP from the SIM card as a spare copy of initial parameters. It is to be noted here that the term “setting” is analogous to the term “parameter” and “communication parameter”.

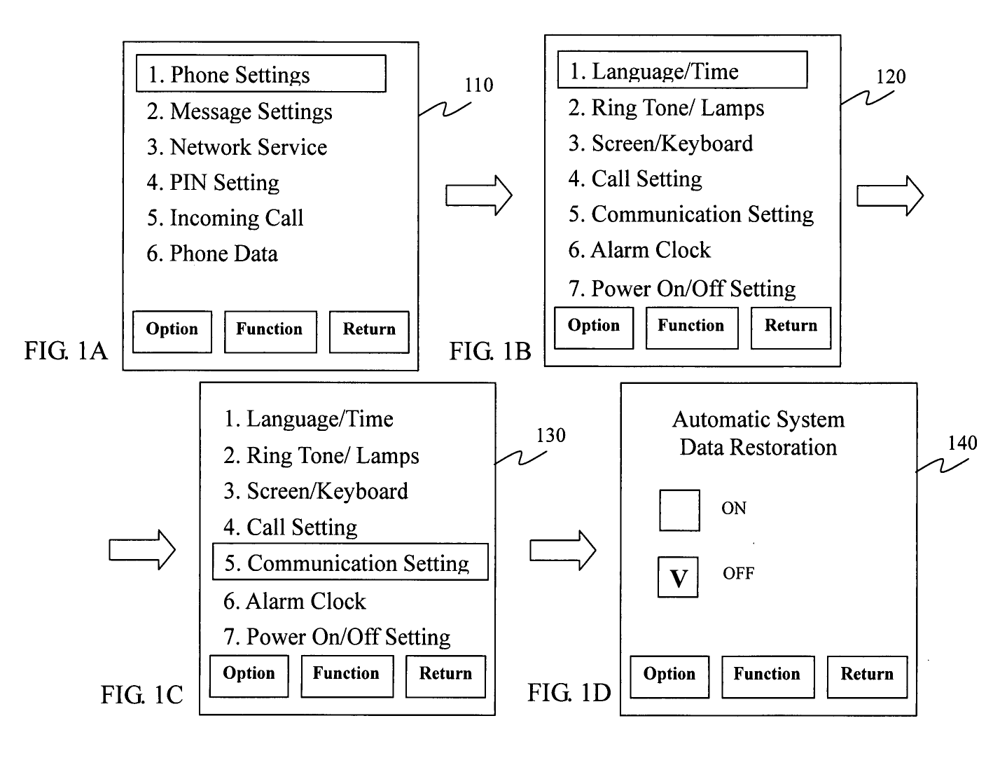

Referring to FIG. 1A, FIG. 1B, FIG. 1C and FIG. ID, option menus displayed when a method of restoring automatically an original setting in a mobile device according to an embodiment of the present invention is performed are shown therein. By manipulating associated keys on the mobile device, selections as to the setting restoration may be made, described as follows.

A modification or selection operation for a setting in the mobile device may be made on an option menu 110 shown in FIG. 1A.

When the “Phone Settings” is selected on the option menu 110 of the mobile device, an option menu 120 associated with the “Phone Settings”, i.e. a sub-directory to the “Phone Settings” is entered, in which a selection item “Language/Time” is default, shown in FIG. 1B.

Then scroll and select a menu option “Communication Settings” on the option menu 130 as shown in FIG. 1C.

Next, a menu option “Automatic System Data Restoration” is entered on the option menu 140, selection items “On” and “Off” are provided to be selected, illustrated in FIG. 1D.

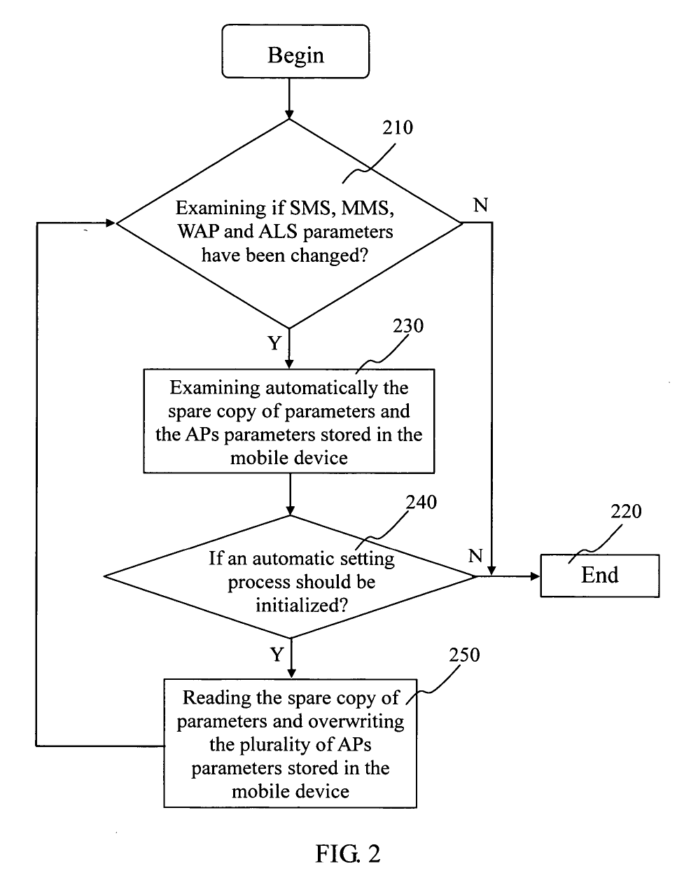

When the user selects the selection item “On” to enter an automatic system data restoration mode corresponding to the theme “Automatic System Data Restoration”, the monitoring module is initialized immediately and the following steps are performed. Referring to FIG. 2, a flowchart illustrating the method of restoring automatically an original setting in a mobile device according to an embodiment of the present invention is shown therein.

First, examining the plurality of APs parameters currently stored in the mobile device and then comparing the examined APs parameters and the spare copy of parameters by the monitoring module (Step 210). Then, the method is stopped when the comparison result shows the APs parameters on the mobile device have not changed (Step 220). Otherwise, examining the initial communication settings currently stored in the mobile device by the monitoring module (Step 230), and verifying if an automatic restoration process should be initialized from an option menu (Step 240). After the verification from the user, performing the initial setting process by the monitoring module and overwriting the current parameters with the spare copy of parameters by the monitoring module (Step 250). If the verification is not received from the user, stopping the method immediately (Step 220). Then, the above process is repeated by going back to Step 210 for a next parameter examining operation.

The directories, option menus and selection items described in the afro-mentioned embodiment are not to be provided in a limiting sense but only a preferred form provided merely in an exemplary sense.

Alternatively, Step 240 mentioned above may be omitted and the automatic restoration process is performed directly when the comparison result shows a difference between the current parameters stored in the mobile device and the spare copy of parameters stored in the monitoring module. In addition, the step of repeating the method after Step 210 may be omitted so as to achieve power and time saving purposes.

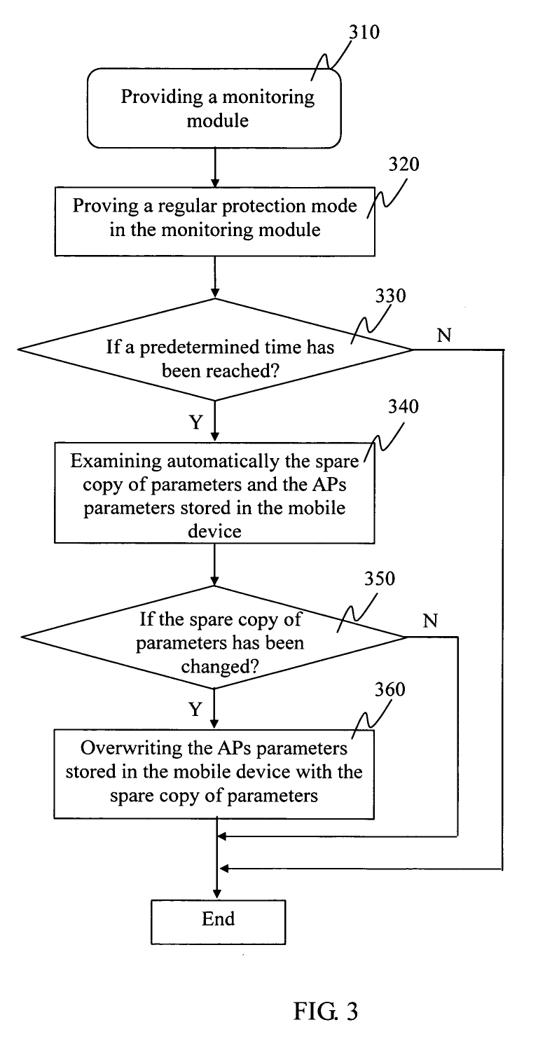

Referring now to FIG. 3, a flowchart illustrating the method of restoring automatically an original setting in a mobile device according to another embodiment of the present invention is shown therein. In this embodiment, the monitoring module is first provided in the mobile device (Step 310) and a regular protection mode is further provided in the monitoring module by proving a timing program or a timing module therein. When the user initializes the setting restoration process (Step 320), the monitoring module begins to examine if a default detection time has been reached with the aid of the timing module (Step 330). Once the default detection time has reached, the plurality of communications settings stored in the mobile device are automatically examined by the monitoring module (Step 340) and the plurality of communications settings are automatically compared to the plurality of APs parameters stored in the monitoring module (Step 350) to see if they are identical.

When the two sets of parameters are not identical, the automatic restoration of Step 240 and the overwriting process of Step 250 mentioned in the above embodiment are performed herein (Step 360). As such, the mobile device is automatically maintained in a normal state where no setting problem is taken place.

Further, on the option menu 140 “Automatic System Data Restoration” shown in FIG. 1 of the mobile device may be additionally provided with a selection item “Regular Restoration” successive to the selection items “Off” and “On”. In this manner, the user may be provided with more modes to select and facilitated with more conveniences.

What is claimed is:

1. A method for restoring automatically an original setting in a mobile device, comprising the steps of:
memorizing a plurality of initial communications settings and APs parameters from a subscriber information module (SIM) card when said SIM card is inserted in said mobile device as a spare copy of parameters;
examining a plurality of access points (APs) parameters stored in said mobile device;
comparing said spare copy of parameters and said plurality of APs parameters on said mobile device to obtain a comparison result; and
executing automatically an initial setting process on said mobile device and overwriting said plurality of APs parameters on said mobile device with the spare copy of parameters when said comparison result shows a different between said spare copy of parameters and said plurality of APs parameters.

2. The method according to claim 1, wherein said mobile device is provided with a monitoring module used to memorize said spare copy of parameters.

3. The method according to claim 1, wherein said mobile device is provided with a monitoring module used to memorize said spare copy of parameters and execute automatically the following steps after said initial setting process is performed:
examining said plurality of APs parameters stored in said mobile device;
comparing said spare copy of parameters and said plurality of APs parameters; and
executing automatically an initial setting process on said mobile device and overwriting said plurality of APs parameters on said mobile device with said spare copy of parameters when said comparison result shows a different between said spare copy of parameters and said plurality of APs parameters.

4. The method according to claim 1, wherein said mobile device is provided with a monitoring module used to memorize said spare copy of parameters and execute automatically each of said steps in said method based on a regular manner on a specific period basis.
